(19) United States
(12) Patent Application Publication
(10) Pub. No.: US 2011/0298757 A1
(43) Pub. Date: Dec. 8, 2011

(54) TOUCH PANEL INPUT SYSTEM AND INPUT PEN

(76) Inventors: Masayuki Hata, Osaka (JP); Kohji Yabuta, Osaka (JP); Toshiaki Nakagawa, Osaka (JP); Toshiyuki Yoshimizu, Osaka (JP)

(21) Appl. No.: 13/201,688

(22) PCT Filed: Oct. 28, 2009
(86) PCT No.: PCT/JP2009/068520

§ 371 Date: Aug. 16, 2011

(30) Foreign Application Priority Data
Mar. 24, 2009 (JP) 2009-072721

(51) Int. Cl. G06F 3/042

(52) U.S. Cl. 345/175

(57) ABSTRACT

A touch panel input system of the present invention includes a touch panel integrated liquid crystal display device (100) and an input pen (60) for carrying out an input with respect to the liquid crystal display device (100). The liquid crystal display device (100) includes a liquid crystal panel (20) that is provided with a plurality of light sensor elements (30) and a backlight (10) that is provided with an infrared LED (12) which emits infrared light. In the liquid crystal panel (20), an infrared light transmitting section (24a) for selectively transmitting light in an infrared region is provided above a corresponding one of the plurality of light sensor elements (30). An infrared light reflecting member (62) is provided at a tip of the input pen (60). This allows obtainment of a touch panel input system which enables detection with high accuracy.

### TECHNICAL FIELD

The present invention relates to an input system which includes (i) a touch panel integrated liquid crystal display device which has a touch panel function and (ii) an input pen which is used to carry out an input with respect to the touch panel integrated liquid crystal display device.

### BACKGROUND ART

Liquid crystal display devices that are under development include a touch panel integrated liquid crystal display device which has a touch panel (an area sensor) function and is capable of determining a part of a panel surface which part is touched with an input pen.

A liquid crystal display device in which each pixel (each set of a plurality of pixels) in an image display region is provided with a corresponding light sensor element such as a photodiode or a phototransistor has been recently developed as such a touch panel integrated liquid crystal display device (see Patent Literature 1, for example). In such a case where each pixel is provided with a corresponding light sensor element, a function as an area sensor (specifically, a scanner function, a touch panel function, or the like) can be implemented in a common liquid crystal display device. Namely, in a case where a light sensor element mentioned above serves as an area sensor, a touch panel (or scanner) integrated liquid crystal display device can be made.

According to such a touch panel integrated liquid crystal display device, a light sensor element recognizes, as an image, a pen or a finger appearing on a display panel, so as to detect and determine a location of a tip of the pen or a tip of the finger. In view of this, in order for a light sensor element to detect a pen input location more securely, a touch panel integrated liquid crystal display device has been devised which includes an input pen provided with a light source such as a light emitting diode.

According to this, an input pen provided with a light source yields an effect such that a light sensor element provided in a liquid crystal display panel can more easily recognize a location of the input pen. This is because light of a light emitting diode is emitted from a tip of the input pen toward the liquid crystal display panel.

Patent Literature 2 discloses a light pen which supplies sensing light to a display device by use of light generated from the display device. The light pen is provided with a light transforming section which has a function of reflecting light at a tip of the light pen. The light pen causes the light transforming section to reflect light from a backlight of a display device such as a liquid crystal panel and then causes a light sensing element provided in the liquid crystal panel to sense the reflected light, so as to carry out an input by use of a pen.

### CITATION LIST

Patent Literature 1
Japanese Patent Application Publication, Tokukai, No. 2006-18219 A (Publication Date: Jan. 19, 2006)

Patent Literature 2
Japanese Patent Application Publication, Tokukai, No. 2005-85265 A (Publication Date: Mar. 31, 2005)

### SUMMARY OF INVENTION

### Technical Problem

However, according to the light pen disclosed in Patent Literature 2, an input location is sensed by use of light from the backlight provided for the display device to carry out a display. Therefore, a sensor output changes depending on a brightness of an image displayed in the display device. Namely, there occurs a problem such that the light pen fails to detect an input location during a black display.

As described earlier, a conventional touch panel integrated liquid crystal display device causes a problem such that an image displayed on a liquid crystal panel may cause a deterioration in detection accuracy of a light sensor.

The present invention has been made in view of the problems, and an object of the present invention is to build a touch panel input system including an input pen which enables detection with higher accuracy.

### Solution to Problem

In order to attain the object, a touch panel input system in accordance with the present invention includes: a liquid crystal display device including (i) a liquid crystal panel that is provided with a plurality of light sensor elements for detecting an intensity of received light and has an area sensor function in which the plurality of light sensor elements detect an image on a panel surface, so as to determine a location of an input from outside and (ii) a backlight that is provided with a light source which emits infrared light; and an input pen for carrying out an input with respect to the liquid crystal display device, an infrared light reflecting member being provided at a tip of the input pen, and an infrared light transmitting section being provided above a corresponding one of the plurality of light sensor elements provided in the liquid crystal panel, and transmitting more light in an infrared region than light outside the infrared region.

According to the arrangement, in a case where a certain part of a top surface of the liquid crystal display device is touched with the input pen, the infrared light reflecting member provided at the tip of the input pen can efficiently reflect infrared light emitted from the backlight. Then, the plurality of light sensor elements detect the reflected infrared light. Note that the plurality of light sensor elements provided in the liquid crystal panel can carry out an output not in accordance with an intensity of visible light but in accordance with an intensity of infrared light since an infrared light transmitting section for transmitting infrared light selectively is provided above a corresponding one of the plurality of light sensor elements.

As described earlier, since the touch panel input system of the present invention is arranged such that an input location is detected by use of infrared light which has nothing to do with a brightness of a display image, it is possible to carry out location determination with high accuracy but with no change in sensor output depending on a brightness of an image displayed on the liquid crystal panel.

Note here that specific examples of a material of which the infrared light reflecting member is made include polycarbonate and aluminum.

The touch panel input system of the present invention can be arranged such that the infrared light reflecting member has a tip which has a protrusion; and a tip of the protrusion has a curvature radius of 0.6 mm or more.

Note here that the tip of the infrared light reflecting member refers to a part of the infrared light reflecting member which part is in contact with the top surface of the liquid crystal display device. According to the arrangement, it is possible to securely determine a location of an input by use of an input pen.

The tip of the protrusion can have a curvature radius of 2.0 mm or less. This allows the tip of the input pen to be curved.

The tip of the protrusion can have a curvature radius of 1.5 mm.

According to the arrangement, a substantially constant sensor output can be obtained by a light sensor element provided below an input location even when an angle at which the input pen is inclined to the top surface of the liquid crystal display device is changed.

The touch panel input system of the present invention can be arranged such that the infrared light reflecting member has a tip which has a recessed surface.

According to the arrangement, since the tip of the infrared light reflecting member has a recessed surface, it is possible to collect light reflected by the recessed surface. This allows the light sensor elements provided in the liquid crystal panel to collect light reflected at the tip of the input pen and enables an increase in sensor output. Therefore, it is possible to carry out location determination with higher accuracy.

The touch panel input system of the present invention can be arranged such that a light blocking section is provided in a part of the recessed surface.

The touch panel input system of the present invention can be arranged such that the tip of the infrared light reflecting member which tip has the recessed surface is provided with a convex lens.

The touch panel input system of the present invention can be arranged such that the infrared light reflecting member is made of polycarbonate or aluminum. According to the arrangement, it is possible to cause the infrared light reflecting member to have a reflectance of 90% or more with respect to infrared light.

In order to attain the object, an input pen in accordance with the present invention for carrying out an input with respect to a liquid crystal display device that is provided with a plurality of light sensor elements for detecting an intensity of received light and has an area sensor function in which the plurality of light sensor elements detect an image on a panel surface, so as to determine a location of an input from outside, the input pen includes an infrared light reflecting member provided at a tip thereof, the infrared light reflecting member having a protrusion whose tip has a curvature radius of 0.6 mm or more.

Note here that the tip of the protrusion of the infrared light reflecting member refers to a part of the infrared light reflecting member which part is in contact with the top surface of the liquid crystal display device when the top surface of the liquid crystal display device is touched with the input pen. According to the arrangement, an input pen can be obtained which is capable of determining an input location more securely.

The input pen can be arranged such that the tip of the protrusion has a curvature radius of 2.0 mm or less. This allows the tip of the input pen to be curved.

The input pen can be arranged such that the tip of the protrusion has a curvature radius of 1.5 mm.

According to the arrangement, a sensor output which is substantially constant with respect to a pen input can be obtained by a light sensor element provided in the liquid crystal display device even when an angle at which the input pen is inclined to the top surface of the liquid crystal display device is changed.

The input pen of the present invention can be arranged such that the infrared light reflecting member is made of polycarbonate or aluminum. According to the arrangement, it is possible to cause the infrared light reflecting member to have a reflectance of 90% or more with respect to infrared light.

In order to attain the object, an input pen in accordance with the present invention for carrying out an input with respect to a liquid crystal display device that is provided with a plurality of light sensor elements for detecting an intensity of received light and has an area sensor function in which the plurality of light sensor elements detect an image on a panel surface, so as to determine a location of an input from outside, the input pen includes an infrared light reflecting member provided at a tip thereof, the infrared light reflecting member having a tip which has a recessed surface.

According to the arrangement, since the tip of the infrared light reflecting member has a recessed surface, it is possible to collect light reflected by the recessed surface. This allows the light sensor elements provided in the liquid crystal display device to collect light reflected at the tip of the input pen and enables an increase in sensor output. Therefore, it is possible to carry out location determination with higher accuracy.

The input pen of the present invention can be arranged such that a light blocking section is provided in a part of the recessed surface.

The input pen of the present invention can be such that the tip of the infrared light reflecting member which tip has the recessed surface is provided with a convex lens.

The input pen of the present invention can be arranged such that the infrared light reflecting member is made of polycarbonate or aluminum. According to the arrangement, it is possible to cause the infrared light reflecting member to have a reflectance of 90% or more with respect to infrared light.

### Advantageous Effects of Invention

A touch panel input system of the present invention is arranged such that (i) an infrared light reflecting member is provided at a tip of the input pen and (ii) an infrared light transmitting section is provided above a corresponding one of the plurality of light sensor elements provided in the liquid crystal panel and transmits more light in an infrared region than light outside the infrared region.

Therefore, according to the touch panel input system of the present invention, it is possible to carry out location determination with high accuracy but with no change in sensor output depending on a brightness of an image displayed on the liquid crystal panel.

### BRIEF DESCRIPTION OF DRAWINGS

FIG. 1 schematically illustrates an arrangement of a touch panel input system in accordance with an embodiment of the present invention.

FIG. 2 illustrates an arrangement of an input pen of the touch panel input system illustrated in FIG. 1.

FIG. 3 schematically illustrates how a panel surface of a liquid crystal display device and the input pen are related to each other in terms of location in the touch panel input system illustrated in FIG. 1.

FIG. 4 is a graph showing how (i) a distance d between the input pen illustrated in FIG. 2 and the panel surface and (ii) a sensor output are related to each other when the input pen is at an angle θ of 90° with respect to the panel surface.

FIG. 5 is a graph showing how (i) the angle θ of the input pen illustrated in FIG. 2 with respect to the panel surface and (ii) the sensor output are related to each other when the distance d between the input pen and the panel surface is 0 mm.

FIG. 6 (a) through (c) of FIG. 6 show alternative arrangement examples of a tip of the input pen.

FIG. 7 is a graph showing how (i) the distance d between the input pen whose tip has a shape as illustrated in (a) of FIG. 6 and the panel surface and (ii) the sensor output are related to each other when the input pen is at the angle θ of 90° with respect to the panel surface.

FIG. 8 is a graph showing how (i) the angle θ of the input pen whose tip has a shape as illustrated in (a) of FIG. 6 with respect to the panel surface and (ii) the sensor output are related to each other when the distance d between the input pen and the panel surface is 0 mm.

FIG. 9 is a graph showing how (i) the distance d between the input pen whose tip has a shape as illustrated in (b) of FIG. 6 and the panel surface and (ii) the sensor output are related to each other when the input pen is at the angle θ of 90° with respect to the panel surface.

FIG. 10 is a graph showing how (i) the angle θ of the input pen whose tip has a shape as illustrated in (b) of FIG. 6 with respect to the panel surface and (ii) the sensor output are related to each other when the distance d between the input pen and the panel surface is 0 mm.

FIG. 11 is a graph showing how (i) the distance d between the input pen whose tip has a shape as illustrated in (c) of FIG. 6 and the panel surface and (ii) the sensor output are related to each other when the input pen is at the angle θ of 90° with respect to the panel surface.

FIG. 12 is a graph showing how (i) the angle θ of the input pen whose tip has a shape as illustrated in (c) of FIG. 6 with respect to the panel surface and (ii) the sensor output are related to each other when the distance d between the input pen and the panel surface is 0 mm.

FIGS. 13

(a) and (b) of FIG. 13 show examples of texts displayed on a liquid crystal panel when a text input is carried out with respect to a conventional touch panel integrated liquid crystal display device by use of a conventional input pen. (a) of FIG. 13 shows the example of a case where an inputted text is displayed in a state in which parts of the inputted text are connected though the parts should not be connected, and (b) of FIG. 13 shows the example of a case where an inputted text is displayed in a state in which parts of the inputted text are disconnected though the parts should be connected.

### DESCRIPTION OF EMBODIMENTS

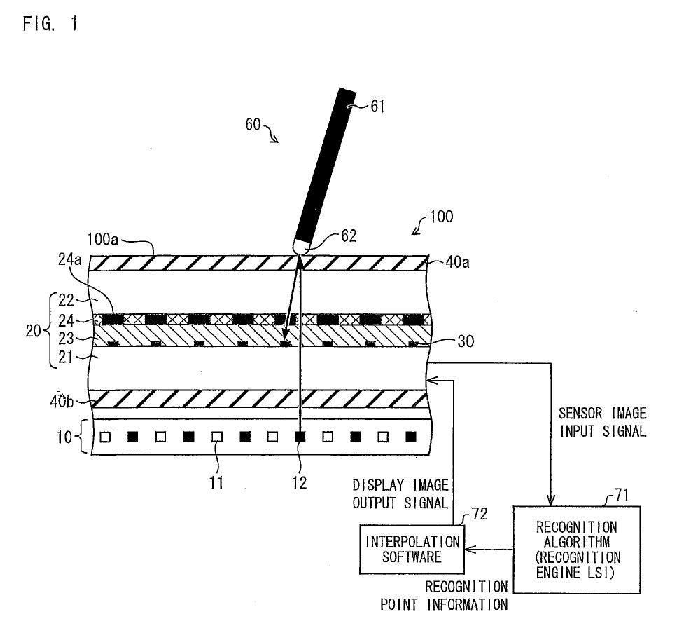

An embodiment of the present invention is described below with reference to FIGS. 1 through 12. Note that the present invention is not limited to the embodiment.

The present embodiment discusses a touch panel input system including (i) a touch panel integrated liquid crystal display device which has a touch panel function and (ii) an input pen which carries out an input of information by its contact with a panel surface of the touch panel integrated liquid crystal display device. Note that the touch panel integrated liquid crystal display device of the present embodiment also has a function of causing a part which has been touched with the input pen to be displayed on a liquid crystal panel. This enables a text and/or a picture written onto the liquid crystal panel by use of the input pen to be displayed on the liquid crystal panel as an image.

First, an arrangement of the touch panel integrated liquid crystal display device of the present embodiment is described below with reference to FIG. 1. A touch panel integrated liquid crystal display device 100 (also referred to as a liquid crystal display device 100) illustrated in FIG. 1 has a touch panel function such that light sensor elements provided in respective pixels detect an image on a surface of a display panel, so as to determine an input location.

The touch panel integrated liquid crystal display device 100 of the present embodiment includes a liquid crystal panel 20 and a backlight 10 which is provided on a backside of the liquid crystal panel 20 and emits light toward the liquid crystal panel 20 (see FIG. 1).

The backlight 10 includes the following two types of light sources: white LEDs 11 which emit white light and infrared LEDs 12 which emit infrared light. A white LED has been commonly used as a light source for displaying an image. In contrast, an infrared LED is used for light sensor elements 30 to determine a location of an input carried out by use of an input pen 60. Namely, in the liquid crystal display device 100, infrared light emitted by the infrared LED is reflected by an infrared light reflecting member provided for the input pen 60 and is then sensed by the light sensor elements 30, so that an input location is determined.

Note that the present embodiment employs, as a light source used for the backlight 10, different kinds of light sources of a white LED and an infrared LED which emit light in different wavelength regions. However, the present invention is not limited to this. Only one kind of LED can be used which is capable of generating light in a wavelength region ranging from a visible region to an infrared region.

The liquid crystal panel 20 includes (i) an active matrix substrate 21 in which many pixels are provided in a matrix pattern, (ii) a counter substrate 22 which is provided to face the active matrix substrate 21, and (iii) a liquid crystal layer 23 which is provided between the active matrix substrate 21 and the counter substrate 22 and serves as a display medium.

A front side polarizing plate 40a is provided on a surface of the counter substrate 22 which surface faces away from the active matrix substrate 21, and a backside polarizing plate 40b is provided on a surface of the active matrix substrate which surface faces away from the counter substrate 22.

Each of the front side polarizing plate 40a and the backside polarizing plate 40b serves as a polarizer. For example, in a case where a vertical alignment liquid crystal material is encapsulated in the liquid crystal layer 23, a normally black liquid crystal display device can be made by providing the front side polarizing plate 40a and the backside polarizing plate 40b so that their respective directions of polarization are in a crossed Nicols relationship.

Note that as optical compensation elements, a front side phase plate (not illustrated) can be provided between the counter substrate 22 and the front side polarizing plate 40a and a backside phase plate (not illustrated) can be provided between the active matrix substrate 21 and the backside polarizing plate 40b. For example, in a case where a vertical alignment liquid crystal material is encapsulated in a liquid crystal layer, a front side phase plate and a backside phase plate are provided to improve a transmittance and a viewing angle characteristic. Note that an arrangement in which none of these phase plates are provided allows carrying out a display.

The active matrix substrate 21 mainly includes TFTs (not illustrated) serving as switching elements to drive respective pixels, an alignment film (not illustrated), and the light sensor elements 30.

The counter substrate 22 mainly includes a color filter layer 24, a counter electrode (not illustrated), and an alignment film (not illustrated). The color filter layer 24 includes (i) red (R), green (G), and blue (B) colored sections, (ii) a black matrix, and (iii) infrared light transmitting sections 24a which transmit only light in an infrared region of light entering the light sensor elements 30 through a panel surface 100a (a surface 100a to be detected).

The infrared light transmitting sections 24a can have a structure in which a red color filter and a blue color filter are stacked or red, green, and blue pigments are mixed. According to such a structure, of the light entering the infrared light transmitting sections 24a through the surface 100a to be detected, the infrared light transmitting sections 24a can block light outside the infrared region and then transmit only light in the infrared region toward the light sensor elements 30.

Note that a structure of the infrared light transmitting sections 24a is not limited to what is described above. Note also that the infrared light transmitting sections 24a do not need to be incorporated in the color filter 24 provided that the light sensor elements 30 can sense infrared light selectively. However, in a case where the infrared light transmitting sections 24a are made from a coloring pigment from which a color filter is made, it is possible to simplify a production process by incorporating the infrared light transmitting sections 24a in the color filter 24.

It is only necessary that an infrared light transmitting section of the present invention be provided above a corresponding one of the light sensor elements 30 (between the surface 100a to be detected and a corresponding one of the light sensor elements 30) and transmit more light in the infrared region than light outside the infrared region.

As described earlier, the touch panel integrated liquid crystal display device 100 of the present embodiment includes the light sensor elements 30 provided in respective pixel regions. This allows implementation of an area sensor function. In a case where a specific part of a top surface (the surface 100a to be detected) of the liquid crystal display device 100 is touched with an input pen, the area sensor function allows the light sensor elements 30 to read the specific part and enables the liquid crystal display device 100 to receive information and carry out an intended operation. The liquid crystal display device 100 of the present embodiment thus allows the light sensor elements 30 to implement a touch panel function.

The liquid crystal display device 100 enables a text and/or a picture written onto the liquid crystal panel 20 by use of the input pen 60 to be displayed on the liquid crystal panel 20 as an image.

The light sensor elements 30 are made of a photodiode or a phototransistor and detect a received light amount by a flow of an electric current in accordance with an intensity of received light. The TFTs and the light sensor elements 30 can be monolithically formed on the active matrix substrate 21 by a substantially identical process. Namely, a part of members of which the light sensor elements 30 are made can be formed simultaneously with a part of members of which the TFTs are made. Such a method for forming a light sensor element can be carried out in conformity with a conventionally publicly known method for producing a light sensor equipped liquid crystal display device.

Note that according to the present invention, a light sensor element is not necessarily provided for each pixel. For example, a light sensor can be provided for each pixel having any one of R, G, and B color filters.

FIG. 1 also illustrates an arrangement which causes a location of an input by use of the input pen 60 which location has been recognized by the light sensor elements 30 to be displayed on the liquid crystal panel 20.

Input information (a sensor image input signal) of the input pen 60 is detected by the light sensor elements 30 and then sent to a recognition engine LSI 71 (see FIG. 1). The recognition engine LSI (a recognition algorithm) 71 calculates an input location (a part which has been touched with the input pen 60) as a recognition point by a sensor image analysis. Namely, in accordance with a received light amount (a received light signal) detected by the light sensor elements 30, the recognition engine LSI 71 calculates coordinates of the input pen 60 with which the top surface of the liquid crystal panel (the surface 100a to be detected) has been touched. Note that the recognition engine LSI 71 allows obtainment of information on a recognition point with which time of an input of the recognition point is associated.

The recognition engine LSI 71 sends a recognition point and information on time of an input of the recognition point as recognition point information to interpolation software 72. In a case where a recognition point does not exist at a given time but a pen location is estimated from information on recognition points followed by and following the recognition point, the interpolation software 72 tracks a change over time in recognition point, so as to generate data assuming that the recognition point exists at the given time. The data generated by the interpolation software 72 is supplied to the liquid crystal panel 20 as a display image output signal. This allows a text and/or the like inputted by use of the input pen 60 to be displayed on the liquid crystal panel 20.

While causing an image to be displayed on the liquid crystal panel 20, the liquid crystal display device 100 as arranged above makes it possible to input a text and/or a picture onto the liquid crystal panel 20 by use of the input pen 60 and display the inputted text and/or the picture on the liquid crystal panel 20 as the image. According to this, it is possible to use the liquid crystal display device 100 for a digital camera in which comments can be inputted to a captured photograph, an electronic game machine in which an executable paint program is provided, or the like.

The following description discusses an arrangement of an input pen used for carrying out a touch panel input with respect to the touch panel integrated liquid crystal display device 100.

The input pen 60 has a body 61 and an infrared light reflecting member 62 provided at a tip of the input pen 60 (see FIG. 1).

The body 61 has an arrangement is arranged as in the case of an input pen which is commonly used as an input pen of a touch panel integrated liquid crystal display device. The infrared light reflecting member 62 is made of a material which reflects infrared light.

A material which has a reflectance preferably of 50% or more, and more preferably of 90% or more with respect to infrared light may be used as the material which reflects infrared light. A specific material of which the infrared light reflecting member 62 is made is polycarbonate, aluminum, or the like. Polycarbonate has a reflectance of 94% with respect to infrared light. Aluminum has a reflectance of 90% with respect to infrared light.

As described earlier, the touch panel input system of the present embodiment is arranged such that light is emitted toward the liquid crystal panel 20 from the backlight 10 whose light sources are a white LED which emits visible light and an infrared LED which emits infrared light. The infrared light reflecting member is provided at a tip of the input pen 60 of the touch panel input system. The infrared light transmitting sections 24a for transmitting infrared light selectively are provided above the respective light sensor elements 30.

According to the arrangement, in a case where a certain part of the surface 100a of the liquid crystal display device 100 is touched with the input pen 60, the infrared light reflecting member 62 provided at the tip of the input pen 60 can efficiently reflect infrared light emitted from the backlight 10. Then, the light sensor elements 30 detect the reflected infrared light. Note that the light sensor elements 30 can carry out an output in accordance with an intensity of infrared light since the infrared light transmitting sections 24a for transmitting infrared light selectively are provided above the respective light sensor elements 30.

As described earlier, according to the touch panel input system of the present embodiment, it is possible to carry out location determination with high accuracy but with no change in sensor output depending on a brightness of an image displayed on the liquid crystal panel 20.

Next, a more preferable embodiment example of the touch panel input system of the present invention is to be described. In advance of the description, a problem is to be described which occurs in a case where a touch panel input is carried out with respect to a conventional touch panel integrated liquid crystal display device by use of a conventional input pen.

For example, in a case where a touch panel input is carried out by use of the light pen described in Patent Literature 2, an amount of light received by a light sensor element provided in a liquid crystal display device does not change so much whether or not a tip of the light pen is in contact with a panel surface. Therefore, it is difficult to clearly determine whether or not a display panel is touched with an input pen.

In a where an inclination of a pen to a top surface of a liquid crystal display device changes, a problem occurs such that a sensor output changes depending on the inclination of the pen due to a difference in reflection from the pen even when an input is carried out with respect to an identical part of the surface.

Some existing touch panel integrated liquid crystal display devices allow an input pen to display input information such as a text on a liquid crystal panel. In such a liquid crystal display device, in a case where a touch/non-touch of a panel surface with an input pen cannot be recognized accurately, an inputted text is displayed in a state in which parts of the inputted text are connected though the parts should not be connected (see (a) of FIG. 13). This is because, even if the input pen is away from the panel surface, a pen input is recognized and thus a line is drawn. In contrast, in a liquid crystal display device in which an inclination of the input pen at a larger angle to the panel surface causes a reduction in sensor output, an inputted text is discontinuous depending on an inclination of the input pen and thus the inputted text is displayed in a state in which parts of the inputted text are disconnected though the parts should be connected (see (b) of FIG. 13).

In view of the circumstances, the following description discusses a more preferable embodiment which can solve the problems described above.

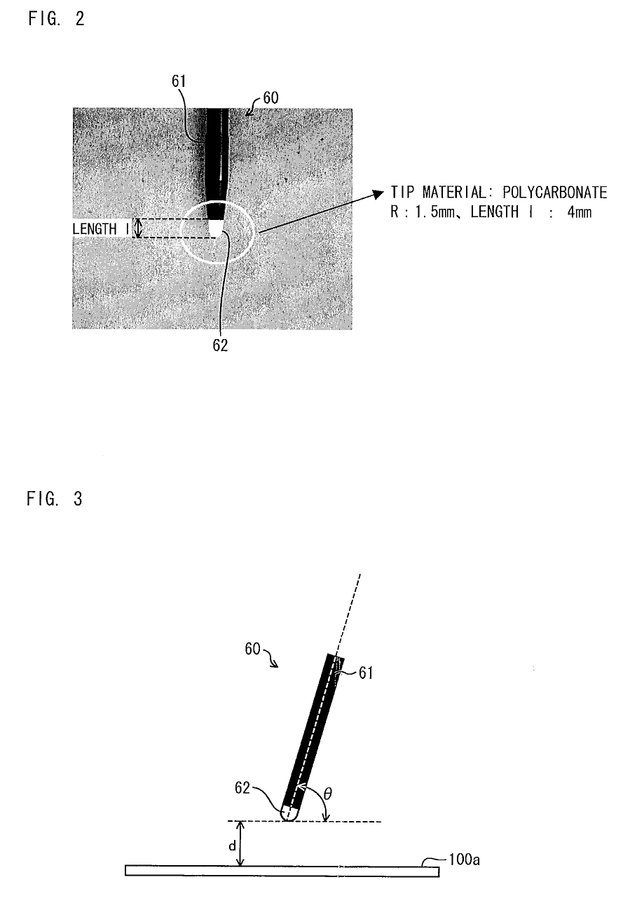

FIG. 2 shows a specific example of the input pen 60 of the present embodiment. In the example of FIG. 2, the infrared light reflecting member 62 is made of polycarbonate. A tip of the infrared light reflecting member 62 has a protruding and curved surface having a curvature radius R of 1.5 mm. The infrared light reflecting member 62 has a length l of 4 mm. Note here that the length of the infrared light reflecting member 62 refers to a length between the tip of the infrared light reflecting member 62 and a connection between the infrared light reflecting member 62 and the body 61.

Note here that the following description discusses a result of examination of how a location (a distance and an inclination) of the input pen 60 with respect to the panel surface 100a and a sensor output are related to each other in a case where a touch panel input is carried out with respect to the liquid crystal display device 100 by use of the input pen 60 illustrated in FIG. 2.

FIG. 3 illustrates how the panel surface 100a of the liquid crystal display device 100 and the input pen 60 are related to each other in terms of location. d indicates a distance between the panel surface 100a and the tip of the input pen 60, and θ indicates an angle at which the input pen 60 is inclined to the panel surface 100a (see FIG. 3).

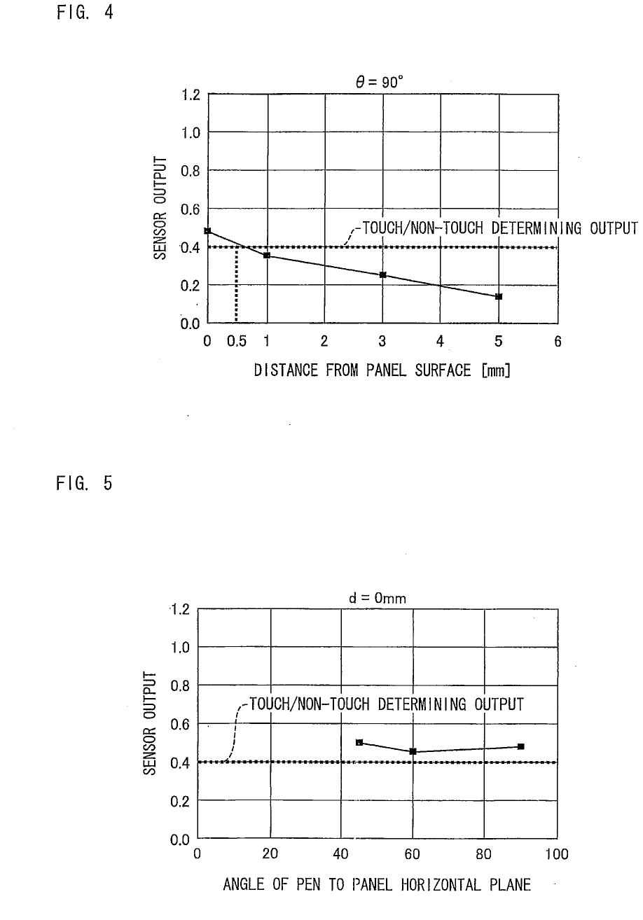

FIG. 4 shows how the distance d and the sensor output (a sensing signal intensity) of the light sensor elements 30 are related to each other when θ=90°. FIG. 5 shows how the angle θ and the sensor output (the sensing signal intensity) of the light sensor elements 30 are related to each other when d=0 mm (namely, the panel surface 100a is touched with the input pen 60). Note that FIG. 5 shows a result obtained in a case where θ is changed from 45° to 90°.

FIG. 4 shows that the sensor output decreases as the distance d is longer (as the tip of the input pen 60 is away from the panel surface 100a). FIG. 5 shows that the sensor output is 0.5 or so and is substantially constant even if the angle θ of the input pen 60 is changed from 45° to 90°.

As described earlier, in a case where the infrared light reflecting member 62 of the input pen 60 is formed as illustrated in FIG. 2, the sensor output which is substantially constant can be obtained by a light sensor element provided below an input location even when the angle at which the input pen 60 is inclined to the top surface (the surface 100a to be detected) of the liquid crystal display device 100 is variously changed between 45° and 90°. Note that an angle of use (an angle necessary for actual use) specified in a common writing instrument such as a ballpoint pen falls within a range of 50° to 90°. Therefore, in a case where the sensor output can be constant at an angle at which the input pen 60 is inclined to the surface 100a and which falls within a range of 45° to 90°, it is possible to carry out favorable location determination in actual use.

As described earlier, according to the present embodiment, optimum formation of the tip of the input pen 60 allows the sensor output to be constant even if the input pen 60 is inclined.

In a case where the input pen 60 is formed as illustrated in FIG. 2, in accordance with the result shown in FIG. 4, the recognition engine LSI 71 is set to “determine that a recognition point exists when the sensor output is 0.4 or more”. According to this, a recognition point is outputted in a case where the distance d is approximately 0.5 mm or less and no recognition point is outputted when the distance d is more than approximately 0.5 mm (see FIG. 4). Note that determination of whether or not a recognition point exists can be similarly carried out also in a case where the input pen 60 is inclined to the surface 100a at an angle of 45° or so (see FIG. 5).

As described earlier, the recognition engine LSI 71, in which a threshold of the sensor output is set, can output, as a recognition point, the sensor output which is obtained in accordance with a signal from the light sensor elements 30 and is not less than the threshold. According to this, it is possible to clearly determine whether or not the top surface 100a of the liquid crystal display device 100 is touched with the input pen 60.

The embodiment example allows carrying out location determination with substantially high accuracy for a simple touch operation carried out by use of an input pen. However, in a case where a handwritten text and/or the like is inputted by use of an input pen, so as to be displayed on a liquid crystal panel, a tip of the input pen may be 0.5 mm or more away from the liquid crystal panel for a moment since the input pen is moved fast. Since no recognition point exists during the moment, parts of the handwritten text are disconnected here and there (see (b) of FIG. 13).

The liquid crystal display device 100 is provided with the interpolation software 72 for solving the problem. In a case where a recognition point does not exist at a given time, the recognition engine LSI 71 tracks a change over time in recognition point, so as to estimate a pen location from information on recognition points followed by and following the recognition point and provide an output as a recognition point. According to this, it is possible to output a correct text by interpolating a space (a part which is not recognized) between the recognition points.

According to the arrangement, it is possible to build a touch panel input system which is capable of not only carrying out a touch operation but also favorably carrying out a text input.

Note that the present invention is not limited to the form of the input pen which form was described above as a preferable example of the present invention. For example, it is preferable that the tip of the infrared light reflecting member 62 have a curvature radius of 1.5 mm. However, in view of an absolute sensitivity threshold (specifically, one and a half or more times a noise level of a sensor) of a sensor system provided in the liquid crystal display device 100, a sensor output seems to be detectable until the curvature radius of the tip of the input pen 60 is reduced to approximately 40% or so of R=1.5 mm. Therefore, it is preferable that the tip of the infrared light reflecting member 62 has a curvature radius of 1.5 (mm)×0.4=0.6 (mm) or more. According to this, a location of an input by use of the input pen 60 can be detected securely by use of the sensor system provided in the liquid crystal display device 100.

In contrast, as the tip of the input pen 60 has a larger curvature radius R, the sensor output increases, so that an S/N ratio increases. Therefore, an upper limit of the curvature radius R is not particularly limited in terms of enhancement of accuracy of the sensor output. However, a desirable upper limit of the curvature radius R of a pen with which a text is inputted is commonly 2.0 mm. This is because R of 2.0 mm or more causes the tip to be too flat. In view of the above description, it is preferable that the tip of the input pen 60 have a curvature radius R of 2.0 mm or less.

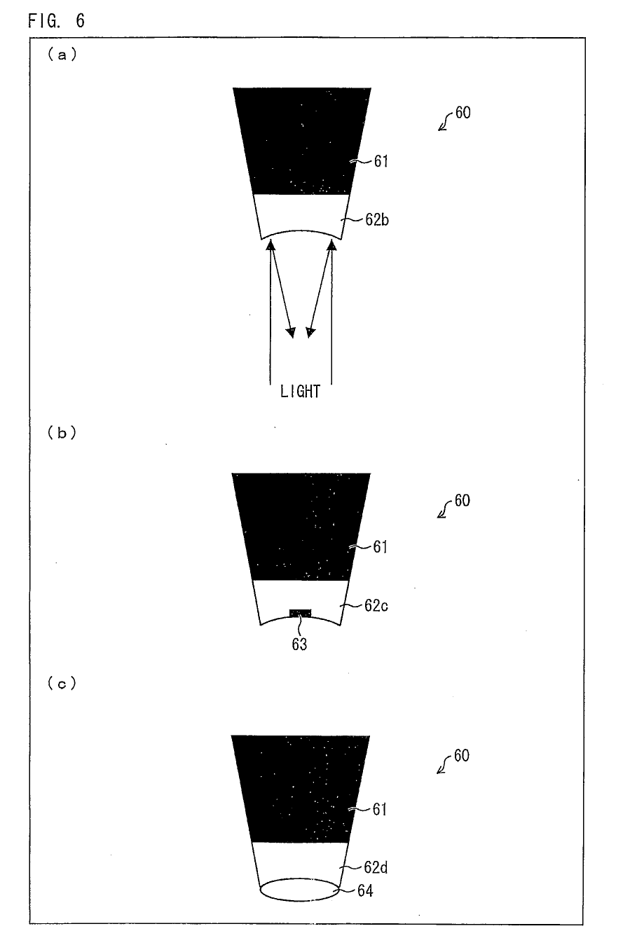

The tip (infrared light reflecting member) of the input pen of the present invention can be formed to protrude as described earlier or can have a recessed surface. (a) through (c) of FIG. 6 show alternative arrangement examples of the infrared light reflecting member provided at the tip of the input pen 60.

The input pen 60 illustrated in (a) of FIG. 6 is arranged such that an infrared light reflecting member 62b provided at a tip of the body 61 has a recessed surface. According to the arrangement, it is possible to collect light reflected by the recessed surface of the infrared light reflecting member 62b. This allows the light sensor elements provided in the liquid crystal panel to collect light reflected at the tip of the input pen and enables an increase in sensor output. Therefore, it is possible to carry out location determination with higher accuracy.

According to the arrangement, it is more preferable to set a curvature of the recessed surface so that light reflected by the recessed surface can be focused on the light sensor elements 30 when the panel surface 100a is touched with the input pen 60. According to this, since the sensor output dramatically decreases during the non-touch due to defocusing on the light sensor elements 30, it is possible to clearly determine whether or not the panel surface is touched with the input pen.

The input pen 60 illustrated in (b) of FIG. 6 is arranged such that an infrared light reflecting member 62c has a recessed surface as in the case of (a) of FIG. 6 and a light blocking section 63 is provided in a part of the recessed surface. According to this, it is possible to keep the sensor output constant even if the angle θ of the input pen 60 is changed.

As described earlier, in a case where the tip of the input pen 60 has a recessed reflection surface, the most powerful light gathering effect is obtained in a direction of 90° with respect to a central part of the recessed surface of the input pen (a direction of 90° with respect to a tangent to a center of the recessed surface). In a case where the central part of the recessed surface in which part the most powerful light gathering effect is obtained is subjected to light blocking, it is possible to prevent an output in the direction of 90° and cause the sensor output obtained when the angle θ of the input pen 60 is 90° to be identical to the sensor output obtained when the input pen 60 is obliquely inclined. As described above, in a case where the light blocking section is provided in the central part of the recessed surface (see (b) of FIG. 6), it is possible to prevent the output in the direction of 90° due to a reflection principle in the recessed surface. Therefore, it is possible to keep the sensor output constant even if the angle θ of the input pen is changed.

Accordingly, it is preferable that the light blocking section 63 be provided in the central part of the recessed surface.

The input pen 60 illustrated in (c) of FIG. 6 is arranged such that an infrared light reflecting member 62d has a recessed surface as in the case of (a) of FIG. 6 and a tip of the infrared light reflecting member 62c is provided with a convex lens 64.

As described earlier, in a case where a recessed mirror surface (reflection surface) and a convex lens are combined, light having entered the input pen 60 is refracted by the convex lens, reflected by the recessed mirror surface, and then refracted when the light outgoes from the convex lens, so that the light can go back (i.e., be retroreflected) in a direction in which the light has entered the input pen 60. According to this, it is possible to keep the sensor output constant even when the input pen 60 is inclined at a larger angle to the panel surface (namely, in a case where the angle θ of the input pen 60 is 90° or more).

Note here that the following description discusses a result of examination of how a location (a distance and an inclination) of the input pen 60 with respect to the panel surface 100a and the sensor output are related to each other in a case where a touch panel input is carried out with respect to the liquid crystal display device 100 by use of the input pens 60 (see (a) through (c) of FIG. 6).

As in the case of the above description, how the panel surface 100a of the liquid crystal display device 100 and the input pen 60 are related to each other in terms of location is such that d indicates a distance between the panel surface 100a and the tip of the input pen 60, and θ indicates an angle at which the input pen 60 is inclined to the panel surface 100a (see FIG. 3).

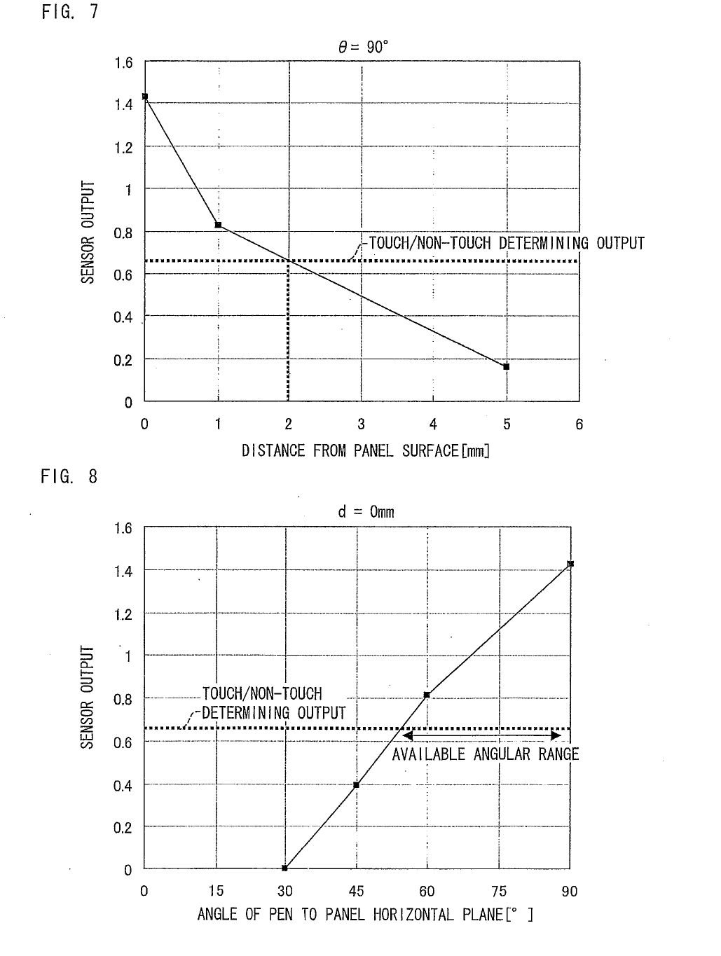

FIG. 7 shows how the distance d and the sensor output (a sensing signal intensity) of the light sensor elements 30 are related to each other when the input pen 60 has the infrared light reflecting member 62b structured as illustrated in (a) of FIG. 6 and θ=90°. FIG. 8 shows how the angle θ and the sensor output (the sensing signal intensity) of the light sensor elements 30 are related to each other when d=0 mm (namely, the panel surface 100a is touched with the input pen 60). Note that FIG. 8 shows a result obtained in a case where θ is changed from 30° to 90°.

FIG. 7 shows that the sensor output decreases as the distance d is longer (as the tip of the input pen 60 is away from the panel surface 100a). Note that a comparison between FIG. 7 and FIG. 4 shows that use of the input pen 60 provided with the infrared light reflecting member 62b having the recessed surface enables obtainment of a higher sensor element than use of the input pen 60 provided with the infrared light reflecting member 62 having a protrusion. However, the sensor output greatly changes when the angle θ of the input pen 60 falls within a range of 30° to 90°. This shows that the sensor output has a large angular dependence.

In accordance with the result shown in FIG. 7, in a case where the input pen 60 is formed as illustrated in Fig. (a) of FIG. 6, the recognition engine LSI 71 is set to “determine that a recognition point exists when the sensor output is 0.68 or more”. According to this, a recognition point is outputted in a case where the distance d is approximately 2.0 mm or less and no recognition point is outputted when the distance d is more than approximately 2.0 mm (see a broken line of FIG. 7).

As described earlier, the recognition engine LSI 71, in which a threshold of the sensor output is set, can output, as a recognition point, the sensor output which is obtained in accordance with a signal from the light sensor elements 30 and is not less than the threshold. According to this, it is possible to clearly determine whether or not the top surface 100a of the liquid crystal display device 100 is touched with the input pen 60.

As described earlier, in a case where the recognition engine LSI 71 is set to “determine that a recognition point exists when the sensor output is 0.68 or more” and the panel surface is touched with the input pen 60 at the angle θ falling within a range of 50° to 90°, the recognition engine LSI 71 determines that a recognition point exists (see a broken line of FIG. 8). As described above, in a case where it is determined that a recognition point exists when an angle at which the input pen is inclined to the panel surface falls within a range of 50° to 90°, it is possible to carry out favorable location determination in actual use.

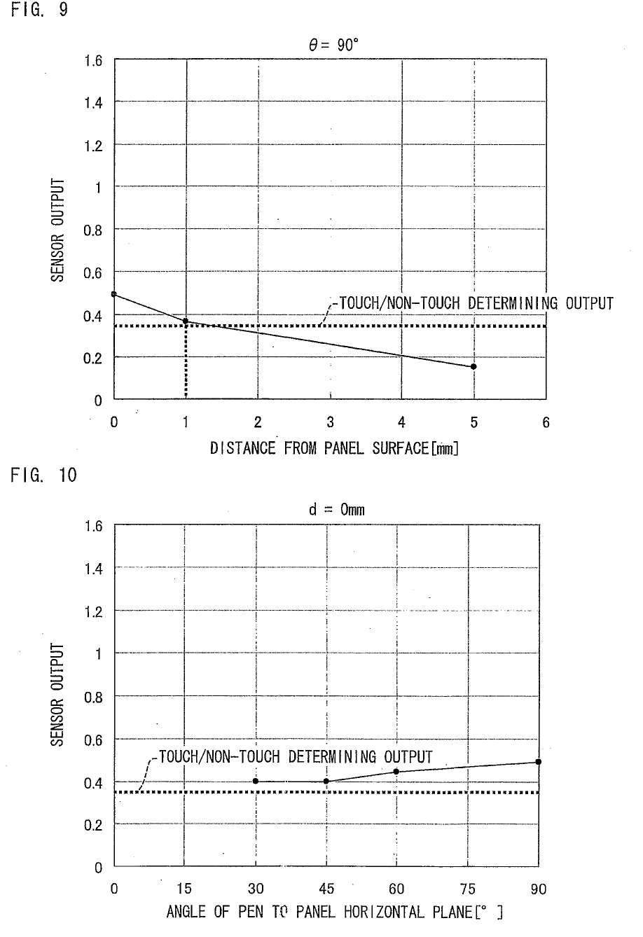

FIG. 9 shows how the distance d and the sensor output (a sensing signal intensity) of the light sensor elements 30 are related to each other when the input pen 60 has the infrared light reflecting member 62c structured as illustrated in (b) of FIG. 6 and θ=90°. FIG. 10 shows how the angle θ and the sensor output (the sensing signal intensity) of the light sensor elements 30 are related to each other when d=0 mm (namely, the panel surface 100a is touched with the input pen 60). Note that FIG. 10 shows a result obtained in a case where θ is changed from 30° to 90°.

FIG. 9 shows that the sensor output decreases as the distance d is longer (as the tip of the input pen 60 is away from the panel surface 100a). FIG. 10 shows that the sensor output is between 0.4 and 0.5 and is substantially constant even if the angle θ of the input pen 60 is changed from 30° to 90°.

As described earlier, in a case where the input pen 60 is structured as illustrated in Fig. (b) of FIG. 6, the sensor output which is substantially constant can be obtained by a light sensor element provided below an input location even when the angle at which the input pen 60 is inclined to the top surface (the surface 100a to be detected) of the liquid crystal display device 100 is variously changed between 30° and 90°.

In a case where the input pen 60 is structured as illustrated in Fig. (b) of FIG. 6, in accordance with the result shown in FIG. 9, the recognition engine LSI 71 is set to “determine that a recognition point exists when the sensor output is 0.35 or more”. According to this, a recognition point is outputted in a case where the distance d is approximately 1.0 mm or less and no recognition point is outputted when the distance d is more than approximately 1.0 mm (see FIG. 9). Note that determination of whether or not a recognition point exists can be similarly carried out also in a case where the input pen 60 is inclined to the surface 100a at an angle of 30° or so (see FIG. 10).

As described earlier, the recognition engine LSI 71, in which a threshold of the sensor output is set, can output, as a recognition point, the sensor output which is obtained in accordance with a signal from the light sensor elements 30 and is not less than the threshold. According to this, it is possible to clearly determine whether or not the top surface 100a of the liquid crystal display device 100 is touched with the input pen 60.

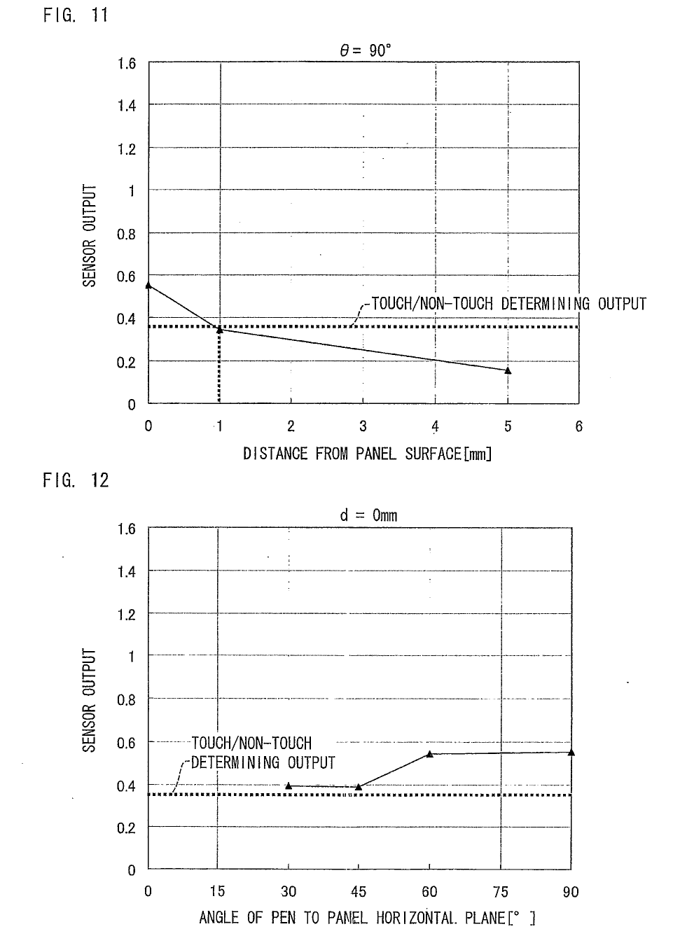

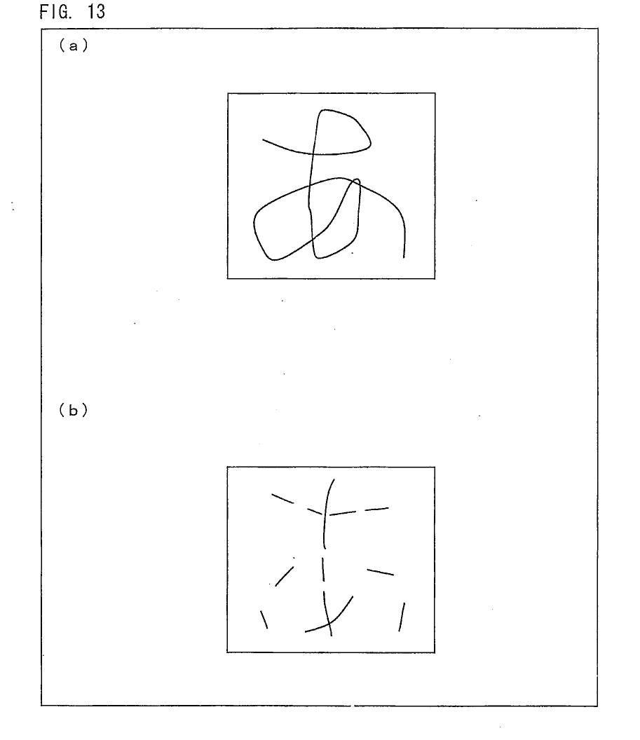

FIG. 11 shows how the distance d and the sensor output (a sensing signal intensity) of the light sensor elements 30 are related to each other when the input pen 60 has the infrared light reflecting member 62d structured as illustrated in (c) of FIG. 6 and the convex lens 64 and θ=90°. FIG. 12 shows how the angle θ and the sensor output (the sensing signal intensity) of the light sensor elements 30 are related to each other when d=0 mm (namely, the panel surface 100a is touched with the input pen 60). Note that FIG. 12 shows a result obtained in a case where θ is changed from 30° to 90°.

FIG. 11 shows that the sensor output decreases as the distance d is longer (as the tip of the input pen 60 is away from the panel surface 100a). FIG. 12 shows that the sensor output is between 0.4 and 0.6 and is substantially constant even if the angle θ of the input pen 60 is changed from 30° to 90°.

As described earlier, in a case where the input pen 60 is structured as illustrated in Fig. (c) of FIG. 6, the sensor output which is substantially constant can be obtained by a light sensor element provided below an input location even when the angle at which the input pen 60 is inclined to the top surface (the surface 100a to be detected) of the liquid crystal display device 100 is variously changed between 30° and 90°.

In a case where the input pen 60 is structured as illustrated in Fig. (c) of FIG. 6, in accordance with the result shown in FIG. 11, the recognition engine LSI 71 is set to “determine that a recognition point exists when the sensor output is 0.35 or more”. According to this, a recognition point is outputted in a case where the distance d is approximately 1.0 mm or less and no recognition point is outputted when the distance d is more than approximately 1.0 mm (see FIG. 11). Note that determination of whether or not a recognition point exists can be similarly carried out also in a case where the input pen 60 is inclined to the surface 100a at an angle of 30° or so (see FIG. 12).

As described earlier, the recognition engine LSI 71, in which a threshold of the sensor output is set, can output, as a recognition point, the sensor output which is obtained in accordance with a signal from the light sensor elements 30 and is not less than the threshold. According to this, it is possible to clearly determine whether or not the top surface 100a of the liquid crystal display device 100 is touched with the input pen 60.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

A touch panel input system of the present invention enables a light sensor equipped liquid crystal display device to carry out location determination with higher accuracy. Accordingly, the touch panel input system of the present invention can be used for a liquid crystal display device having a touch panel function. Further, the touch panel input system of the present invention makes it possible to carry out an input operation with high accuracy by use of an input pen and to cause inputted information to be displayed on a liquid crystal display panel. Therefore, the touch panel input system of the present invention can be used for a digital camera in which comments can be inputted to a captured photograph, an electronic game machine in which an executable paint program is provided, or the like.

### REFERENCE SIGNS LIST

10 Backlight
11 White LED (Light source)
12 Infrared LED (Light source)
20 Liquid crystal panel
21 Active matrix substrate
22 Counter substrate
23 Liquid crystal layer
24 Color filter layer
24a Infrared light transmitting section
30 Light sensor element
60 Input pen
61 Body
62 Infrared light reflecting member
62b Infrared light reflecting member
62c Infrared light reflecting member
62d Infrared light reflecting member
63 Light blocking section
64 Convex lens
71 Recognition engine LSI
72 Interpolation software
100 Touch panel integrated liquid crystal display device (Liquid crystal display device)
100a Panel surface (Surface to be detected)

1. A touch panel input system comprising:
a liquid crystal display device including (i) a liquid crystal panel that is provided with a plurality of light sensor elements for detecting an intensity of received light and has an area sensor function in which the plurality of light sensor elements detect an image on a panel surface, so as to determine a location of an input from outside and (ii) a backlight that is provided with a light source which emits infrared light; and
an input pen for carrying out an input with respect to the liquid crystal display device,
an infrared light reflecting member being provided at a tip of the input pen, and
an infrared light transmitting section being provided above a corresponding one of the plurality of light sensor elements provided in the liquid crystal panel, and transmitting more light in an infrared region than light outside the infrared region.

2. The touch panel input system as set forth in claim 1, wherein:
the infrared light reflecting member has a tip which has a protrusion; and
a tip of the protrusion has a curvature radius of 0.6 mm or more.

3. The touch panel input system as set forth in claim 2, wherein the tip of the protrusion has a curvature radius of 2.0 mm or less.

4. The touch panel input system as set forth in claim 2, wherein the tip of the protrusion has a curvature radius of 1.5 mm.

5. The touch panel input system as set forth in claim 1, wherein the infrared light reflecting member has a tip which has a recessed surface.

6. The touch panel input system as set forth in claim 5, wherein a light blocking section is provided in a part of the recessed surface.

7. The touch panel input system as set forth in claim 5, wherein the tip of the infrared light reflecting member which tip has the recessed surface is provided with a convex lens.

8. The touch panel input system as set forth in claim 1, wherein the infrared light reflecting member is made of polycarbonate or aluminum.

9. An input pen for carrying out an input with respect to a liquid crystal display device that is provided with a plurality of light sensor elements for detecting an intensity of received light and has an area sensor function in which the plurality of light sensor elements detect an image on a panel surface, so as to determine a location of an input from outside,
said input pen comprising an infrared light reflecting member provided at a tip thereof,
the infrared light reflecting member having a protrusion whose tip has a curvature radius of 0.6 mm or more.

10. The input pen as set forth in claim 9, wherein the tip of the protrusion has a curvature radius of 2.0 mm or less.

11. The input pen as set forth in claim 9, wherein the tip of the protrusion has a curvature radius of 1.5 mm.

12. The input pen as set forth in claim 9, wherein the infrared light reflecting member is made of polycarbonate or aluminum.

13. An input pen for carrying out an input with respect to a liquid crystal display device that is provided with a plurality of light sensor elements for detecting an intensity of received light and has an area sensor function in which the plurality of light sensor elements detect an image on a panel surface, so as to determine a location of an input from outside,
said input pen comprising an infrared light reflecting member provided at a tip thereof,
the infrared light reflecting member having a tip which has a recessed surface.

14. The input pen as set forth in claim 13, wherein a light blocking section is provided in a part of the recessed surface.

15. The input pen as set forth in claim 13, wherein the tip of the infrared light reflecting member which tip has the recessed surface is provided with a convex lens.

16. The input pen as set forth in claim 13, wherein the infrared light reflecting member is made of polycarbonate or aluminum.
